(19) United States
(12) Patent Application Publication
(10) Pub. No.: US 2024/0318783 A1
(43) Pub. Date: Sep. 26, 2024

(54) MINI LIQUID-NITROGEN INJECTOR

(71) Applicant: CVS CORPORATION, Gimpo-si, Gyeonggi-do (KR)

(72) Inventor: Han Bhin KO, Seoul (KR)

(73) Assignee: CVS CORPORATION, Gimpo-si, Gyeonggi-do (KR)

(21) Appl. No.: 18/578,977

(22) PCT Filed: Aug. 22, 2022
(86) PCT No.: PCT/KR2022/012481

§ 371 Date: Jan. 12, 2024

(30) Foreign Application Priority Data
Sep. 6, 2021 (KR) 10-2021-0118113

(51) Int. Cl. F17C 5/02; F17C 13/02

(52) U.S. Cl. CPC F17C 5/02; F17C 13/02; F17C 2205/0338; F17C 2221/014

(57) ABSTRACT

A mini liquid-nitrogen injector injects liquid nitrogen into an aluminum can when drinks and the like are packed at small shops and the like, so as to enable movement and distribution, and thus long-term storage is possible, and a predetermined amount of liquid nitrogen is injected into a can facilitating eating, so as to push out oxygen therein and allow nitrogen, which is an inert gas, to occupy the space, so that, during packing, in order to inhibit microbial propagation and prevent taste alteration, liquid nitrogen is injected into an aluminum can, thereby enabling movement and distribution.

### TECHNICAL FIELD

The present disclosure relates to a mini liquid-nitrogen injector, and more particularly to a mini liquid-nitrogen injector which injects liquid nitrogen into aluminum cans or plastic cans when packaging beer, beverages, etc. in small stores, seals them, and packages them for transport and distribution.

### DESCRIPTION OF THE RELATED ART

Currently, there is no way to prevent homemade canned drinks from being crushed. In general, handmade cans are crushed as the volume of the beverage filled inside decreases due to temperature differences. A way to prevent canned beverages from being crushed is to add a small amount of liquid nitrogen right before sealing the can lid, so that the liquid nitrogen inside evaporates, expands in volume, increases internal pressure, and prevents the can itself from being crushed. This method has the advantage of extending the shelf life by removing the amount of dissolved oxygen inside the can.

In general, beverages and food in cans that can be stored for a long time and are easily consumed are injected with a certain amount of liquid nitrogen into the storage containers to prevent them from being distorted. In general, it is known that when liquid nitrogen is injected, the oxygen inside is pushed out and nitrogen, an inert gas, takes up space, inhibiting microbial propagation and preventing taste alteration.

The liquid nitrogen is liquefied nitrogen and is a substance that exists in the atmosphere at around −196 degrees. This liquid nitrogen is colorless and transparent and harmless to the human body, so it is used in various fields, including the food industry. The beverage cans we currently consume are filled with beverages in a storage container, then injected with a certain amount of liquid nitrogen and sealed with a lid. It is widely used as it can prevent the container from being crushed due to pressure as the liquid nitrogen injected into the container vaporizes.

The mini liquid-nitrogen injector according to the present disclosure is a device that seals hot or cold beverages in a beverage can for convenient portability and movement. Currently, devices for sealing beverage cans are widely used in small stores, but depending on the temperature and contents of the beverage, the air inside the beverage can shrinks over time after sealing, causing the can itself to become distorted and its shape to change, so it is used limitedly. Therefore, in order to prevent such shape deformation, if liquid nitrogen is poured before sealing the beverage can, the liquid nitrogen vaporizes inside the beverage can and compensates for the amount of air shrinkage, so the beverage can can be stored firmly and in its original shape.

Currently, liquid nitrogen injectors are used in large factory facilities to seal beer and other beverages into cans. However, the liquid nitrogen injectors used in these factories were manufactured to facilitate mass production, so the machine volume itself was large and installation costs were high, making it difficult for ordinary small shops to use.

(Patent Document 1) Korean Patent Publication No. 10-2014-2257 describes a liquid nitrogen injection device that discharges the pressure when the internal pressure is above the standard and maintains the standard pressure.

(Patent Document 2) Korean Registered Patent No. 10-1279304 describes an injector that injects a fixed amount into beverage cans used in mass production.

(Patent Document 3) However, the above inventions was manufactured to facilitate mass production, and like the present disclosure, a liquid injector that reduces the equipment itself for directly injecting liquid nitrogen is needed to be useful for small quantity production.

### SUMMARY OF THE INVENTION

An object of the present disclosure is to provide a liquid-nitrogen injector that quickly and safely injects liquid nitrogen into beverage cans, etc. with a small equipment and improves insulation.

Therefore, the present disclosure provides a small, mini liquid nitrogen injector that reduces the configuration of the conventional liquid injector to the minimum and allows individual business owners to easily use the liquid injector in handmade coffee shops, juice shops, and general stores.

In addition, another object of the present disclosure is to detect the container using a photo sensor and install a timer to allow the user to directly control the injection time and inject a desired amount of liquid nitrogen.

In order to solve the above problems, the present disclosure is characterized by including a liquid nitrogen supply pipe that supplies liquid nitrogen to an outer tank and a discharge pipe that discharges gaseous nitrogen, a level sight glass to check how much cryogenic liquid nitrogen remains installed at the upper part of the outer tank, a nozzle cylinder that injects gaseous nitrogen of the inner tank while a stem rod extends and moves from the upper part of the outer tank, a buffer tank that always maintains the pressure at 4 kg/cm2 by the regulator's set pressure, a timer and a photo sensor that detect a container can in the photo sensor mounted in the middle of the vertical cylindrical pillar on a base plate and allow liquid nitrogen to be injected for a set injection time, a nozzle box mounted and connected to the lower part of the inner tank in the outer tank and consisting of a nozzle stem, an injection nozzle, and a nozzle body in a panoramic shape, and a gas nitrogen supply pipe that maintains a positive pressure of gas nitrogen supplied from the upper part of the inner tank and blocks external air from penetrating, wherein a double vacuum is formed between the inner tank and the outer tank, and the nozzle body is in the form of a zigzag connected to the inner tank and has a good insulation effect by blocking conductive heat.

In addition, the injection nozzle maintains an optimal temperature of 40 degrees by heat generation of the nozzle stem and nozzle heating block using a temperature sensor and temperature controller, and in order to prevent the icing phenomenon in which the nozzle inlet is frozen and blocked by the conductive heat of the liquid nitrogen stored in the inner tank, a nozzle stem pin smaller than the nozzle inlet is assembled at the bottom of the nozzle stem to block the nozzle hole, preventing water from freezing and clogging the nozzle hole.

In addition, the timer of the control panel is characterized in that it controls the injection amount of liquid nitrogen by setting the injection amount of liquid nitrogen in 1/100 second units.

In addition, the temperature of the nozzle heating block is set to 40 degrees and is always maintained at 40 degrees when the power is turned on.

In addition, the level unit installed in the form of a hollow pipe inside the inner tank may allow the filling level of liquid nitrogen to be checked on the level sight glass by a level float operated by a spring.

In addition, the nozzle is injected directly without cooling down the nozzle by processing and assembling a metal nozzle inlet into a two-stage hole with a cryogenic material.

When liquid nitrogen is injected and sealed through the mini liquid-nitrogen injector of the present disclosure, the can is never distorted and has the effect of preventing taste alteration by inhibiting microbial propagation inside the can.

### BRIEF DESCRIPTION OF THE DRAWINGS

FIG. 1 shows a mini liquid-nitrogen injector according to the present disclosure.

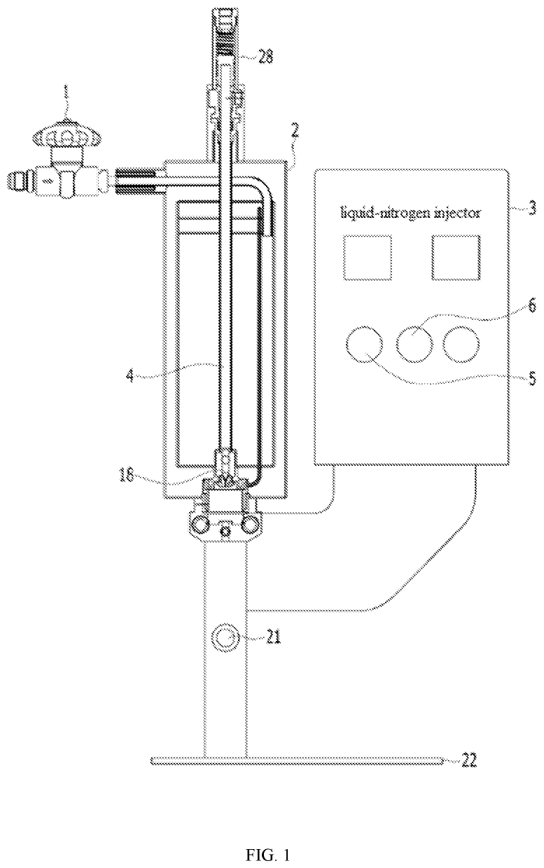

FIG. 2 is a diagram explaining the operating process of the mini liquid-nitrogen injector according to the present disclosure.

### DETAILED DESCRIPTION OF THE INVENTION

When explaining the mini liquid-nitrogen injector of the present disclosure, the mini liquid-nitrogen injector of the present disclosure largely consists of a liquid nitrogen discharge device (not shown) and a mini liquid-nitrogen injector. The liquid nitrogen discharge device is a type of liquid nitrogen storage tank for fixed-quantity injection by continuously supplying liquid nitrogen to the liquid nitrogen injector, and continuously supplies liquid nitrogen discharged through a device installed at the upper part of the storage tank to the mini liquid-nitrogen injector through a supply pipe.

The mini liquid-nitrogen injector of the present disclosure, as shown from the outside, is composed of a clamp 1, an outer storage tank 2, a nozzle cylinder 28, a nozzle stem 4, a leveler, a control panel 3 that sets a timer and temperature, a heating box that injects liquid nitrogen from the lower part of the tank, a photo sensor 24, and a base plate 22. First, when liquid nitrogen flows from the liquid nitrogen storage tank into the liquid nitrogen storage tank through the device, the tank is filled with liquid nitrogen and a certain amount of liquid nitrogen is injected into the can using the photo sensor 24. In the nozzle cylinder 28 installed at the upper part of the mini liquid-nitrogen injector, the stem 4 rod is lowered longitudinally to the bottom inside the liquid nitrogen inner tank by supplying liquid nitrogen, and the nozzle stem 4 rod moves up and down by the release of gaseous nitrogen, injecting liquid nitrogen through the nozzle, a float level rod is installed in the inner tank in the vertical and longitudinal direction, the bottom of the level rod is held by a spring mounted at the bottom, so that the float level rod moves up and down according to the amount of liquid nitrogen remaining in the inner tank, and the user recognizes the presence or absence of liquid nitrogen filling by looking at the level sight glass mounted next to the nozzle cylinder.

A thermostat (5) mounted on the control panel of the mini liquid-nitrogen injector controls the temperature of the heating box nozzle, always heats the bottom of the nozzle to 40 degrees to remove moisture at the bottom and prevents the nozzle from freezing and clogging at the temperature of liquid nitrogen, which is −196. In addition, the installed timer 6 adjusts the injection time of liquid nitrogen and thus the amount of liquid nitrogen discharged through the nozzle. That is, when the timer 6 is set longer, the amount of liquid nitrogen discharged and injected into the can increases.

In other words, the heating box installed at the bottom of the liquid nitrogen outer tank always maintains the temperature at 40 degrees using the thermostat 5 to prevent the nozzle from freezing due to liquid nitrogen, and in order to inject a fixed amount of liquid nitrogen into a can on the mini liquid-nitrogen injector base plate 22, when the user manually touches the beverage can on the base plate 22, the photo sensor 24 installed on the pillar of the base plate 22 detects the beverage can, liquid nitrogen is injected through the nozzle for an injection time preset by the timer 6, and then the lid of the beverage can is sealed in the seaming machine.

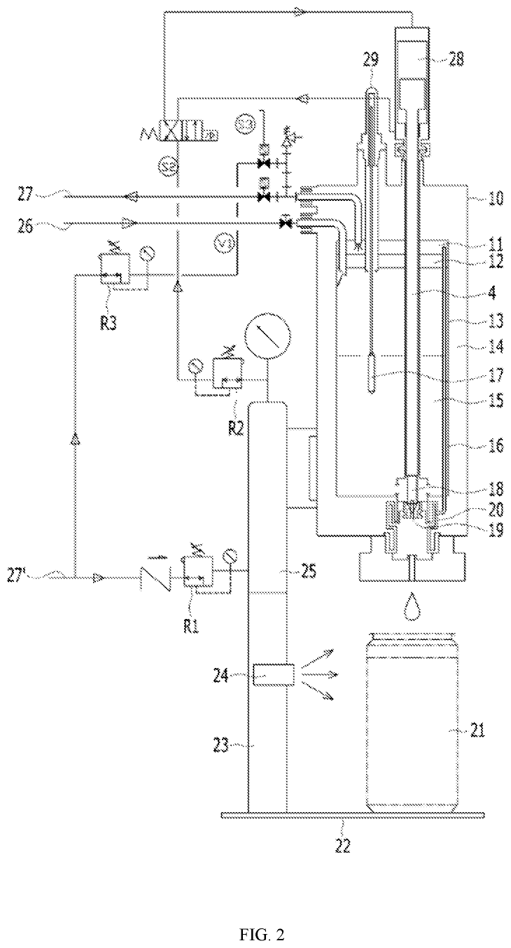

The operation of the mini liquid-nitrogen injector of the present disclosure will be described in detail with reference to FIG. 2.

The mini liquid-nitrogen injector of the present disclosure consists of an outer storage tank 10, an inner storage tank 13, a nozzle cylinder 28, a control panel, regulators R1, R2, R3, a liquid nitrogen supply pipe 26, a gaseous nitrogen discharge pipe 27, a solenoid nozzle valve, a level sight glass 29 connected to a level floater 17, a nozzle stem 18, a panoramic nozzle body 20, a heat-blocking nozzle 19, a photo sensor 24, and a base plate 22. Looking at the operation, first, when electricity is supplied to the control panel and the power selection switch is turned on, the S3 gas nitrogen supply valve is closed, the S1 and S2 valves are opened, the nozzle cylinder 28 is advanced and closed, and the gas discharge valve is opened to supply liquid nitrogen. When the liquid nitrogen is supplied, it consists of an inner tank 13 and an outer tank 10, there is a gas-liquid separation space 12 and a gas space 11 above the inner tank, there is a vacuum state 14 between the inner tank and the outer tank, and liquid nitrogen is stored in the inner tank 13.

Next, the S1 solenoid valve moves the nozzle cylinder 28 forward and the nozzle closes. Here, by setting the pressure of the R1 regulator connected to the tank to 6 kg/cm2 and the pressure of R2 to 4 kg/cm2, even when the gaseous nitrogen pressure decreases after supplying gaseous nitrogen, the pressure in the buffer tank 25 can always be maintained at about 5 kg/cm2 by the set pressure of the R1 regulator and R2 regulator.

Meanwhile, the R2 regulator supplies gaseous nitrogen to the nozzle cylinder 28 at a pressure of 4 kg/cm2 and keeps the cylinder speed constant. Here, the amount of liquid nitrogen supplied is also adjusted uniformly.

When the liquid nitrogen supply valve V1 is opened, the liquid nitrogen supplied from the liquid nitrogen storage tank is supplied to the inner tank 13 of the mini liquid nitrogen injector to cool down the inner tank, when the inner tank 13 is filled with liquid nitrogen, the level float 17 begins to float to the upper part by the connected spring, and when it reaches the middle of the sight glass 29, the user can confirm that the liquid nitrogen has been completely filled in the inner tank 13. In this case, the inner tank 13 is filled with an appropriate amount of liquid nitrogen, so the V1 valve is closed.

Next, in order to seal the can 21, when a can 21 filled with a beverage is placed in front of the port sensor 24, upon detection by the port sensor 24, the S1 solenoid valve opens for a preset injection time, retracts the nozzle stem 18, and at this time, liquid nitrogen is injected downward through the tube-shaped stem 4 rod. While the liquid nitrogen is injected through the stem (4) rod, after the set time of the timer 6 installed on the liquid nitrogen injector panel 3 has elapsed, the S1 solenoid valve is closed again, and through this process, a certain amount of liquid nitrogen can be supplied to the can 21 each time. Here, if the internal pressure of the beverage can container is low, the time setting time is extended, and if the internal pressure is high, the time setting time is shortened to always maintain a constant amount of liquid nitrogen entering the can.

Meanwhile, as shown in the drawing, gaseous nitrogen is supplied to a nozzle box consisting of a nozzle stem 18, an injection nozzle 19, and a panoramic nozzle body 20, and by connecting the nozzle box and the gas space at the upper part of the inner tank 13, the gaseous nitrogen supply pipe 16, which maintains positive pressure in the nozzle box in the inner tank 13, supplies vaporized liquid nitrogen into the nozzle box to maintain positive pressure inside the nozzle box and blocks the infiltration of external air. In addition, when the injector operates, the nozzle surface prevents icing due to the ultra-low temperature of the nozzle hole due to the liquid nitrogen, while allowing liquid nitrogen to be injected in a fixed amount.

Here, the panoramic nozzle body 20 in the nozzle box is used to block cryogenic heat conducted to the outside in advance by configuring the heat conduction passage in a zigzag panoramic shape as shown in order to block cryogenic heat conducted from the liquid nitrogen stored in the internal tank.

Next, when explaining the operation of the nozzle cylinder 28 and the liquid nitrogen injection method, the operation of the nozzle cylinder 28 causes the nozzle cylinder 28 to retract due to the electromagnet operation of the solenoid valve when the user places the can 21 container on the port sensor 24, so that the liquid nitrogen is injected into the container can for a period of time preset by the timer 6 on the control panel 3, and the lid of the container can 21 into which liquid nitrogen has been injected is sealed using a sealing machine.

When a certain number of container cans 21 are filled with liquid nitrogen from the inner tank 13, liquid nitrogen must be replenished from the liquid nitrogen storage tank, and at this time, the user checks the level sight glass 29 where the level float 17 is connected and visible. That is, it is installed vertically in the cylindrical hollow pipe inner tank 13 and a level unit is inserted inside, when liquid nitrogen is insufficient, the level unit is raised upward by a spring mounted on the lower part of the level float 17 floating on the liquid, and the presence or absence of liquid nitrogen filling can be checked through the upper level sight glass, and accordingly liquid nitrogen filled in the liquid nitrogen storage tank is continuously supplied.

In addition, the injection nozzle 19 fastened within the nozzle box is manufactured using cryogenic materials in consideration of icing, and serves to continuously supply liquid nitrogen without the effect of cool-down when used, and a nozzle stem pin is inserted into the nozzle hole at the bottom end of the nozzle stem 18 to prevent the nozzle hole from freezing due to temperature and clogging when filling liquid nitrogen into a can.

In addition, by installing a timer inside the panel and setting to slightly longer than the injection time, a prevention circuit installed in the control panel of the present disclosure can sound an alarm buzzer when liquid nitrogen is injected longer than the injection time. This can prevent liquid nitrogen from being overfilled in the can container beyond the set amount or set time.

The present disclosure prevents deterioration due to a decrease in the amount of dissolved oxygen in the aluminum cans filled with homemade coffee, fruit drinks, and pet food by injecting liquid nitrogen into the cans, prevents the cans from being crushed due to volume changes due to temperature, and can be used in cafes and other businesses.

What is claimed is:

1. A mini liquid-nitrogen injector comprising:
a liquid nitrogen supply pipe that supplies liquid nitrogen to an outer tank and a discharge pipe that discharges gaseous nitrogen,
a level sight glass to check how much cryogenic liquid nitrogen remains installed at the upper part of the outer tank,
a nozzle cylinder that injects gaseous nitrogen of the inner tank while a stem rod extends and moves from the upper part of the outer tank,
a buffer tank that always maintains the pressure at 4 kg/cm2 by the regulator's set pressure,
a timer and a photo sensor that detect a container can in the photo sensor mounted in the middle of the vertical cylindrical pillar on a base plate and allow liquid nitrogen to be injected for a set injection time,
a nozzle box mounted and connected to the lower part of the inner tank in the outer tank and consisting of a nozzle stem, an injection nozzle, and a nozzle body in a panoramic shape, and
a gas nitrogen supply pipe that maintains a positive pressure of gas nitrogen supplied from the upper part of the inner tank and blocks external air from penetrating,
wherein a double vacuum is formed between the inner tank and the outer tank, and the nozzle body in a panoramic shape is in the form of a zigzag connected to the inner tank and has a good insulation effect by blocking conductive heat.

2. The mini liquid-nitrogen injector according to claim 1,
wherein the injection nozzle maintains an optimal temperature of 40 degrees by heat generation of the nozzle stem and nozzle heating block using a temperature sensor and temperature controller, and in order to prevent the icing phenomenon in which the nozzle inlet is frozen and blocked by the conductive heat of the liquid nitrogen stored in the inner tank, a nozzle stem pin smaller than the nozzle inlet is assembled at the bottom of the nozzle stem to block the nozzle hole, preventing water from freezing and clogging the nozzle hole.

3. The mini liquid-nitrogen injector according to claim 1,
wherein the timer controls the injection amount of liquid nitrogen by setting the injection amount of liquid nitrogen in 1/100 second units.

4. The mini liquid-nitrogen injector according to claim 2,
wherein the temperature of the nozzle heating block is set to 40 degrees and is always maintained at 40 degrees when the power is on.

5. The mini liquid-nitrogen injector according to claim 1,
wherein the level unit installed in the form of a hollow pipe inside the inner tank allows the filling level of liquid nitrogen to be checked on the level sight glass by a level float operated by a spring.

6. The mini liquid-nitrogen injector according to claim 1,
wherein the nozzle is injected directly without cooling down the nozzle by processing and assembling a metal nozzle inlet into a two-stage hole with a cryogenic material.
